(19) United States
(12) Patent Application Publication
(10) Pub. No.: US 2024/0286088 A1
(43) Pub. Date: Aug. 29, 2024

(54) ZEOLITE MEMBRANE COMPLEX, MEMBRANE REACTOR, AND METHOD OF PRODUCING ZEOLITE MEMBRANE COMPLEX

(71) Applicant: NGK INSULATORS, LTD., Nagoya-City (JP)

(72) Inventors: Shunsuke KAMATA, Nagoya-City (JP); Kenichi NODA, Nagoya-City (JP); Naoto KINOSHITA, Nagoya-City (JP); Ryotaro YOSHIMURA, Kasugai-City (JP)

(73) Assignee: NGK INSULATORS, LTD., Nagoya-City (JP)

(21) Appl. No.: 18/641,496

(22) Filed: Apr. 22, 2024

Related U.S. Application Data
(63) Continuation of application No. PCT/JP2022/041965, filed on Nov. 10, 2022.

(30) Foreign Application Priority Data
Nov. 12, 2021 (JP) 2021-184979

(51) Int. Cl. B01D 71/02; B01J 8/00

(52) U.S. Cl. CPC B01D 71/0281; B01J 8/009

(57) ABSTRACT

A zeolite membrane complex includes a porous support and a zeolite membrane made of an LTA-type zeolite and formed on the support. The zeolite membrane has a Si/Al molar ratio of higher than or equal to 1.74 and lower than or equal to 2.80, or the zeolite membrane has a Si/Al molar ratio of higher than or equal to 1.2 and, in an X-ray diffraction pattern obtained by X-ray irradiation of the surface of the zeolite membrane, at least either a peak intensity around 2θ=24.0° or a peak intensity around 2θ=30.0° is 0.85 times or more a peak intensity around 2θ=7.2°.

### CROSS-REFERENCE TO RELATED APPLICATIONS

The present application is a continuation application of International Application No. PCT/JP2022/41965 filed on Nov. 10, 2022, which claims priority to Japanese Patent Application No. 2021-184979 filed on Nov. 12, 2021. The contents of these applications are incorporated herein by reference in their entirety.

### TECHNICAL FIELD

The present invention relates to a zeolite membrane complex, a membrane reactor, and a method of producing the zeolite membrane complex.

### BACKGROUND ART

Zeolite membranes are conventionally used as separation membranes using a molecular-sieving function. A zeolite membrane is typically formed on a porous support, and a resultant substance is treated as a zeolite membrane complex. For example, Japanese Patent Application Laid-Open No. H7-185275 (Document 1) discloses a separation membrane in which a zeolite membrane having an LTA-type crystal structure (A-type zeolite membrane) is deposited on a porous support. It is disclosed that the zeolite membrane is synthesized by hydrothermal synthesis and the composition ratio of starting materials therein is adjusted such that the SiO₂/Al₂O₃ molar ratio is in the range of 2 to 6, the H₂O/Na₂O molar ratio is in the range of 20 to 300, and the Na₂O/SiO₂ molar ratio is in the range of 0.3 to 2.

International Publication No. 2020/261795 (Document 2) describes as a problem that an LTA-type zeolite membrane typically has a Si/Al ratio of approximately 1 and this ratio is insufficient in terms of thermal stability and hydrothermal stability. In view of this, Document 2 realizes the production of an LTA-type zeolite membrane that has a Si/Al ratio of 1.29 to 1.60. Document 2 also describes that an LTA-type zeolite membrane having a Si/Al ratio of 1.70 is weak. “Framework stabilization of Si-rich LTA zeolite prepared in organic-free media” by Marlon T. Conato and other four members, Chem. Commun., 2015, vol. 51, pp. 269-272 (Document 3) describes the synthesis of LTA-type zeolite powder having a Si/Al ratio of 1.7 to 2.1. “Synthesis and Characterization of A-Type Zeolites” by R. H. JARMAN and other two members, ACS Symposium Series, American Chemical Society, 1983, vol. 218, pp. 267-281 (Document 4) describes the synthesis of LTA-type zeolite powder having a Si/Al ratio of 1.16 to 2.99.

As described previously, in Document 2, the LTA-type zeolite membrane can have improved hydrothermal endurance (hydrothermal stability) by setting the Si/Al ratio in the range of 1.29 to 1.60, but this is not necessarily sufficient. Besides, the increased Si/Al ratio in the LTA-type zeolite membrane reduces the strength of the zeolite membrane complex and becomes a problem in practical use. There is thus demand for a zeolite membrane complex with improved hydrothermal endurance and/or strength.

### SUMMARY OF THE INVENTION

The present invention is intended for a zeolite membrane complex, and it is an object of the present invention to provide a zeolite membrane complex with improved hydrothermal endurance and/or strength.

A first aspect of the present invention is a zeolite membrane complex that includes a porous support and a zeolite membrane made of an LTA-type zeolite and formed on the support. The zeolite membrane has a Si/Al molar ratio of higher than or equal to 1.74 and lower than or equal to 2.80.

Accordingly it is possible to provide the zeolite membrane complex with improved hydrothermal endurance.

A second aspect of the present invention is the zeolite membrane complex according to the first aspect, in which in an X-ray diffraction pattern obtained by X-ray irradiation of a surface of the zeolite membrane, at least either a peak intensity around 2θ=24.0° or a peak intensity around 2θ=30.0° is 0.85 times or more a peak intensity around 2θ=7.2°.

A third aspect of the present invention is a zeolite membrane complex that includes a porous support, and a zeolite membrane made of an LTA-type zeolite and formed on the support. The zeolite membrane has a Si/Al molar ratio of higher than or equal to 1.2, and in an X-ray diffraction pattern obtained by X-ray irradiation of a surface of the zeolite membrane, at least either a peak intensity around 2θ=24.0° or a peak intensity around 2θ=30.0° is 0.85 times or more a peak intensity around 2θ=7.2°.

Accordingly, it is possible to provide the zeolite membrane complex with improved strength.

A fourth aspect of the present invention is the zeolite membrane complex according to any one of the first to third aspects, in which the zeolite membrane has a thickness of less than or equal to 5 μm.

A fifth aspect of the present invention is the zeolite membrane complex according to any one of the first to fourth aspects, in which when a mixed solution having a temperature of 60° C. and containing 50 mass % of water and 50 mass % of ethanol is supplied with a permeate pressure of −94.66 kPaG, a total permeation flux is higher than or equal to 2.0 kg/m² h, and a separation factor of water to ethanol is greater than or equal to 2000.

The present invention is also intended for a membrane reactor. A sixth aspect of the present invention is a membrane reactor that includes the zeolite membrane complex according to any one of the first to fifth aspects, a catalyst that accelerates a chemical reaction of a starting material, a reactor in which the zeolite membrane complex and the catalyst are placed, and a supplier that supplies the starting material to the reactor. The zeolite membrane complex separates a high-permeability substance having high permeability in a mixture of substances from other substances by allowing the high-permeability substance to permeate the zeolite membrane complex, the mixture of substances containing a product substance generated by a chemical reaction of the starting material in the presence of the catalyst.

The present invention is also intended for a method of producing a zeolite membrane complex. A seventh aspect of the present invention is a method of producing a zeolite membrane complex that includes a) preparing a starting material solution by mixing a sodium source, an aluminum source, and a silicon source with water, b) after the operation a), stirring the starting material solution for 10 hours or more, c) immersing a porous support in the starting material solution, the porous support having a seed crystal deposited thereon, the seed crystal including an LTA-type zeolite, and d) after 70 minutes or more has elapsed since completion of the operation b), heating the starting material solution to form a zeolite membrane made of an LTA-type zeolite on the support with the seed crystal deposited thereon. The starting material solution has a SiO₂/Al₂O₃ molar ratio of higher than or equal to 4 and lower than or equal to 7, an H₂O/Na₂O molar ratio of higher than or equal to 100 and lower than or equal to 1200, and a Na₂O/SiO₂ molar ratio of higher than or equal to 0.1 and lower than or equal to 0.6.

An eighth aspect of the present invention is the method of producing a zeolite membrane complex according to the seventh aspect, in which the starting material solution has an H₂O/Na₂O molar ratio of higher than or equal to 350.

A ninth aspect of the present invention is the method of producing a zeolite membrane complex according to the seventh or eighth aspect, in which the seed crystal has a Si/Al molar ratio of higher than or equal to 2.4.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a sectional view of a zeolite membrane complex.

FIG. 2 is a sectional view showing part of the zeolite membrane complex in enlarge dimensions.

FIG. 3 is a diagram showing an X-ray diffraction pattern obtained from a surface of a zeolite membrane.

FIG. 4 is a flowchart showing the production of a zeolite membrane complex.

FIG. 5 is a diagram showing a separation apparatus.

FIG. 6 is a flowchart showing the separation of a mixture of substances.

### DETAILED DESCRIPTION

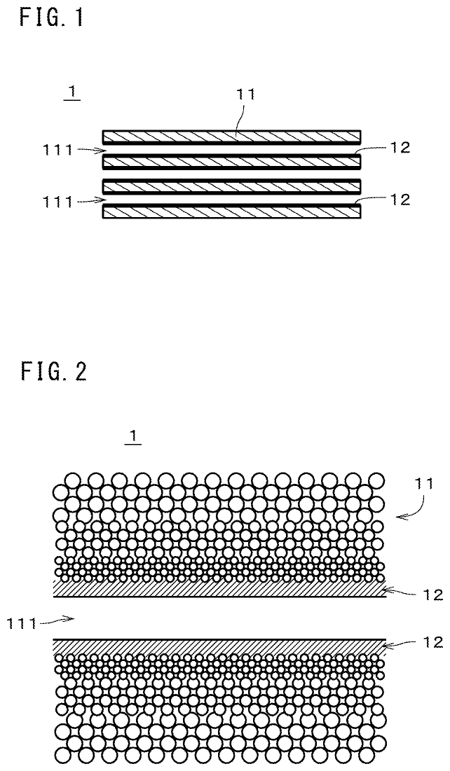

FIG. 1 is a sectional view of a zeolite membrane complex 1. FIG. 2 is a sectional view showing part of the zeolite membrane complex 1 in enlarged dimensions. The zeolite membrane complex 1 includes a porous support 11 and a zeolite membrane 12 formed on the support 11. The zeolite membrane refers to at least a zeolite formed into a membrane on the surface of the support 11 and does not include a membrane formed by simply dispersing zeolite particles in an organic membrane. In FIG. 1, the zeolite membrane 12 is illustrated with thick lines. In FIG. 2, the zeolite membrane 12 is hatched. In FIG. 2, the thickness of the zeolite membrane 12 is illustrated greater than the actual thickness.

The support 11 is a porous member that is permeable to gas and liquid. In the example shown in FIG. 1, the support 11 is a monolith support in which a plurality of through holes 111 each extending in the longitudinal direction (i.e., in the right-left direction in FIG. 1) are provided in an integrally-molded column-like body. In the example shown in FIG. 1, the support 11 has an approximately column-like shape. Each through hole 111 (i.e., cell) may have, for example, an approximately circular cross-sectional shape perpendicular to the longitudinal direction. In FIG. 1, the diameter of the through holes 111 is illustrated greater than the actual diameter, and the number of through holes 111 is illustrated smaller than the actual number. The zeolite membrane 12 is formed on the inside surfaces of the through holes 111 and covers approximately the entire inside surfaces of the through holes 111.

The support 11 may have a length (i.e., length in the right-left direction in FIG. 1) of, for example, 10 cm to 200 cm. The outside diameter of the support 11 may be in the range of, for example, 0.5 cm to 30 cm. The distance between the central axes of each pair of adjacent through holes 111 may be in the range of, for example, 0.3 mm to 10 mm. The surface roughness (Ra) of the support 11 may be in the range of, for example, 0.1 μm to 5.0 μm and preferably in the range of 0.2 μm to 2.0 μm. Note that the support 11 may have any other shape such as a honeycomb shape, a flat plate-like shape, a tube-like shape, a cylinder-like shape, a column-like shape, or a prism shape. In the case where the support 11 has a tube- or cylinder-like shape, the thickness of the support 11 may be in the range of, for example, 0.1 mm to 10 mm.

The material for the support 11 may be any of various substances (e.g., ceramic or metal) as long as the substance has chemical stability in the process of forming the zeolite membrane 12 on the surface. In the present embodiment, the support 11 is formed of a ceramic sintered body. Examples of the ceramic sintered body selected as the material for the support 11 include alumina, silica, mullite, zirconia, titania, yttria, silicon nitride, and silicon carbide. In the present embodiment, the support 11 contains at least one type of substances selected from among the group consisting of alumina, silica, and mullite.

The support 11 may contain an inorganic binding material. The inorganic binding material may, for example, be at least one of titania, mullite, easily sinterable alumina, silica, glass frit, clay minerals, and easily sinterable cordierite.

The support 11 may have a mean pore diameter of, for example, 0.01 μm to 70 μm and preferably 0.05 μm to 25 μm. The mean pore diameter of the support 11 in the vicinity of the surface on which the zeolite membrane 12 is formed may be in the range of 0.01 μm to 1 μm and preferably in the range of 0.05 μm to 0.5 μm. The mean pore diameter may be measured by, for example, a mercury porosimeter, a perm-porometer, or a nano-perm-porometer. Referring to the pore size distribution of the support 11 as a whole including the surface and the interior, D5 may be in the range of, for example, 0.01 μm to 50 μm, D50 may be in the range of, for example, 0.05 μm to 70 μm, and D95 may be in the range of, for example, 0.1 μm to 2000 μm. The porosity of the support 11 in the vicinity of the surface on which the zeolite membrane 12 is formed may be in the range of, for example, 20% to 60%.

For example, the support 11 may have a multilayer structure in which a plurality of layers having different mean pore diameters are laminated one above another in the thickness direction. A mean pore diameter and a sintered particle diameter of a surface layer that includes the surface on which the zeolite membrane 12 is formed are smaller than mean pore diameters and sintered particle diameters o layers other than the surface layer. The mean pore diameter of the surface layer of the support 11 may be in the range of, for example, 0.01 μm to 1 μm and preferably in the range of 0.05 μm to 0.5 μm. In the case where the support 11 has a multilayer structure, the material for each layer may be any of the substances described above. A plurality of layers forming the multilayer structure may be formed of the same material, or may be formed of different materials.

The zeolite membrane 12 is a porous membrane having minute pores (micropores). The zeolite membrane 12 is usable as a separation membrane that separates a specific substance from a mixture of a plurality of types of substances, by using the molecular-sieving function. The zeolite membrane 12 is less permeable to the other substances than to the specific substance. In other words, the permeance of the zeolite membrane 12 to the other substances is lower than the permeance of the zeolite membrane 12 to the aforementioned specific substance.

The thickness of the zeolite membrane 12 may be in the range of, for example, 0.05 μm to 30 μm, preferably in the range of 0.1 μm to 20 μm, and more preferably in the range of 0.5 μm to 10 μm. Reducing the thickness of the zeolite membrane 12 increases permeance. Thus, the thickness of the zeolite membrane 12 is yet more preferably less than or equal to 5 μm. On the other hand, increasing the thickness of the zeolite membrane 12 improves separation performance. The surface roughness (Ra) of the zeolite membrane 12 may, for example, be less than or equal to 5 μm, preferably less than or equal to 2 μm, more preferably less than or equal to 1 μm, and yet more preferably less than or equal to 0.5 μm. The thickness and surface roughness of the zeolite membrane 12 may be acquired by observing a section of the zeolite membrane 12 with a scanning electron microscope (SEM).

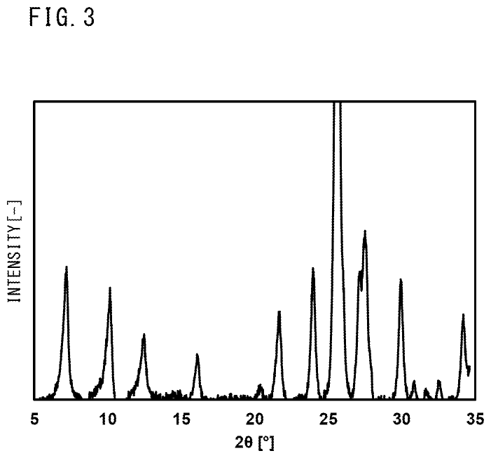

The zeolite membrane 12 is composed of a zeolite having an LTA-type structure. In other words, the zeolite membrane 12 is made of a zeolite with a framework type code of “LTA” assigned by the International Zeolite Association. The X-ray diffraction pattern shown in FIG. 3 and obtained from the surface of the zeolite membrane 12, which will be described later, matches the X-ray diffraction pattern assumed from the LTA-type zeolite structure in peak positions. The zeolite membrane 12 is typically composed of only an LTA-type zeolite, but depending on the production method or the like, the zeolite membrane 12 may contain a slight amount (e.g., 1 mass % or less) of substances other than the LTA-type zeolite.

The maximum number of membered rings of the LTA-type zeolite is eight. An eight-membered ring pore refers to a micropore of a portion where eight oxygen atoms form a ring structure by being bonded to T atoms, which will be described later. The LTA-type zeolite has an intrinsic pore diameter of 0.41 nm. The pore diameter of the zeolite membrane 12 is smaller than the mean pore diameter of the support 11 in the vicinity of the surface on which the zeolite membrane 12 is formed.

One example of the LTA-type zeolite that composes the zeolite membrane 12 is an alumino silicate zeolite in which atoms (T atoms) each located in the center of an oxygen tetrahedron (TO₄) are composed of silicon (Si) and aluminum (Al). Some of the T atoms may be replaced by other elements (e.g., Ti, B, or P). By so doing, it is possible to change the pore diameter or adsorption properties.

The Si/Al molar ratio in the zeolite membrane 12 (the value obtained by dividing the number of moles of Si atoms by the number of moles of Al atoms; the same applies below) is higher than or equal to 1.2. Thus, it is possible to improve the hydrothermal endurance of the zeolite membrane 12 to some extent. As will be described later, hydrothermal endurance can be evaluated by the degree of degradation in separation performance before and after the zeolite membrane complex 1 is immersed in heated water. From the viewpoint of further improving hydrothermal endurance, the Si/Al molar ratio may preferably be higher than or equal to 1.74, more preferably higher than or equal to 1.85, and yet more preferably higher than or equal to 2.0. In the case where the Si/Al molar ratio is higher than 2.80, it becomes difficult to form a dense membrane. Thus, the Si/Al molar ratio may preferably be less than or equal to 2.80. The Si/Al molar ratio in the zeolite membrane 12 can be adjusted by, for example, adjusting a compounding ratio in a starting material solution, which will be described later (the same applies to the ratio of other elements). The Si/Al molar ratio is measurable by energy dispersed X-ray spectroscopy (EDS) analysis conducted on a section of the zeolite membrane 12.

Typically, the zeolite membrane 12 contains alkali metal. The alkali metal may, for example, be sodium (Na). The zeolite membrane 12 may contain any other alkali metal. In one example of the production of the zeolite membrane 12, an organic substance called a structure-directing agent (hereinafter, also referred to as an “SDA”) is not used. However, the production of the zeolite membrane 12 may use the SDA. In this case, it is preferable that the SDA is almost or completely removed after the formation of the zeolite membrane 12. By so doing, it is possible to properly ensure pores in the zeolite membrane 12. The SDA may, for example, be tetramethylammonium hydroxide.

FIG. 3 is a diagram showing one example of the X-ray diffraction (XRD) pattern obtained by X-ray irradiation of the surface of the zeolite membrane 12. The X-ray diffraction pattern shown in FIG. 3 is acquired by using CuKα rays as a radiation source of an X-ray diffractometer. As described previously, the X-ray diffraction pattern obtained from the zeolite membrane 12 matches the X-ray diffraction pattern assumed from the LTA-type zeolite structure in peak positions.

In the X-ray diffraction pattern of the zeolite membrane 12, at least either the peak intensity around 2θ (diffraction angle)=24.0° or the peak intensity around 2θ=30.0° (or preferably both) may, for example, be 0.85 times or more the peak intensity around 2θ=7.2°. A peak around 2θ=24.0° is present in the range of 2θ=24.0°±0.5° and derived from the (622) plane of the LTA-type zeolite. A peak around 20=30.0° is present in the range of 2θ=30.0°±0.5° and derived from the (820) or (644) plane of the zeolite. A peak around 2θ=7.2° is present in the range of 2θ=7.2°±0.5° and derived from the (200) plane of the zeolite.

For example, referring to the X-ray diffraction pattern of the LTA-type zeolite membrane in FIG. 6 in International Publication No. 2020/261795 (Document 2 described above), both of the peak intensity around 2θ=24.0° and the peak intensity around 2θ=30.0° are less than 0.85 times the peak intensity around 2θ=7.2° (in actuality, the both are about 0.8 times). In other words, in the LTA-type zeolite membrane according to Document 2, it is conceivable that the peak intensity around 2θ=7.2° is relatively high and zeolite crystals are oriented to growth. Accordingly, increasing the Si/Al molar ratio makes the zeolite membrane more brittle and reduces the strength of the zeolite membrane.

In contrast, in the zeolite membrane 12, at least either the peak intensity around 2θ=24.0° or the peak intensity around 2θ=30.0° is 0.85 times or more the peak intensity around 2θ=7.2°, and the peak intensity around 2θ=7.2° is relatively low. Thus, it is conceivable that zeolite crystals are not oriented and are grown at random. Accordingly, even if the Si/Al molar ratio becomes higher, the zeolite membrane 12 is less likely to become weak and ensures a certain degree of strength. The strength of the zeolite membrane 12 can be evaluated by the degree of degradation in separation performance before and after a hydraulic pressure test, which will be described later.

In order to more reliably increase the strength of the zeolite membrane 12, it is preferable that the peak intensity around 2θ=24.0° is 0.90 times or more and more preferably 0.95 times or more the peak intensity around 2θ=7.2°. The same applies to the peak intensity around 2θ=30.0°. Ordinarily, the peak intensity around 2θ=24.0° does not become excessively high with respect to the peak intensity around 2θ=7.2°, and for example, the peak intensity around 2θ=24.0° may be three times or less the peak intensity around 2θ=7.2°. The same applies to the peak intensity around 2θ=30.0°. Note that the peak intensity uses a height of the X-ray diffraction pattern except a line of the bottom thereof, i.e., the background noise components. The line of the bottom of X-ray diffraction pattern may be obtained by, for example, the Sonneveld-Visser method or a spline interpolation method.

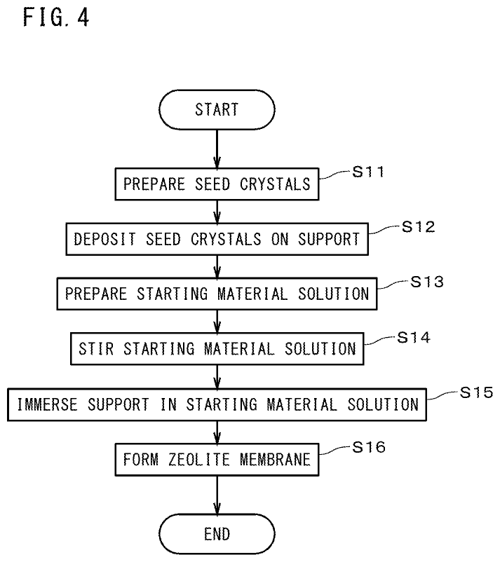

Next, one example of the procedure for producing the zeolite membrane complex 1 will be described with reference to FIG. 4. In the production of the zeolite membrane complex 1, firstly, seed crystals used to produce the zeolite membrane 12 are prepared (step S11). For example, the seed crystals may be acquired from LTA-type zeolite powder that is generated by hydrothermal synthesis. The LTA-type zeolite powder may also be generated by an arbitrary or known production method. By way of example, the LTA-type zeolite powder is generated by hydrothermal synthesis of a solution similar to a starting material solution, which will be described later. In the case where the solution contains an SDA, the zeolite powder is subjected to heat treatment so as to almost completely remove the SDA in the powder by combustion. The zeolite powder may be used as-is as the seed crystals, or the zeolite powder may be processed by, for example, pulverization to acquire seed crystals. In order to more reliably produce the zeolite membrane complex 1 with improved hydrothermal endurance and/or strength, it is preferable that the Si/Al molar ratio in the seed crystals may be high to some extent and may, for example, be higher than or equal to 2.4. There are no particular limitations on the upper limit for the Si/Al molar ratio in the seed crystals, but the upper limit may, for example, be 5.

Then, the porous support 11 is immersed in dispersion liquid in which the seed crystals are dispersed, so that the seed crystals are deposited on the support 11 (step S12). Alternatively, the seed crystals may be deposited on the support 11 by bringing dispersion liquid in which the seed crystals are dispersed into contact with a portion of the support 11 on which the zeolite membrane 12 is desired to be formed. In this way, a seed-crystal-deposited support is prepared. The seed crystals may be deposited on the support 11 by any other technique.

A starting material solution that is used to generate the zeolite membrane 12 is also prepared (step S13). For example, the starting material solution may be prepared by mixing a Si source, an Al source, and a Na source with water (H₂O). Examples of the Si source include colloidal silica, fumed silica, tetraethoxysilane, and sodium silicate. Examples of the Al source include sodium aluminate, aluminum isopropoxide, aluminum hydroxide, boehmite, sodium aluminate, and alumina sol. Examples of the Na source include sodium hydroxide, sodium aluminate, sodium chloride, and sodium silicate. The starting material solution may contain an SDA. Examples of the SDA include tetramethylammonium hydroxide, tetramethylammonium chloride, tetramethylammonium bromide, and diethylmethylammonium hydroxide.

If it is assumed that all the Si source exists as SiO₂ and all the Al source exists as Al₂O₃ in the starting material solution, the SiO₂/Al₂O₃ molar ratio may preferably be in the range of 4 to 7. If it is assumed that all the Na source exists as Na₂O, the H₂O/Na₂O molar ratio may preferably be in the range of 100 to 1200. In order to more reliably increase the Si/Al molar ratio in the zeolite membrane 12, the H₂O/Na₂O molar ratio may preferably be higher than or equal to 350. The H₂O/Na₂O molar ratio may be higher than or equal to 550. The Na₂O/SiO₂ molar ratio may preferably be in the range of 0.1 to 0.6. The SDA/Al₂O₃ molar ratio may preferably be in the range of 0 to 2. The starting material solution may be mixed with any other raw material.

After the preparation of the starting material solution, the starting material solution is stirred for 10 hours or more (step S14). The stirring of the starting material solution may be conducted by any of various known techniques. The temperature of the starting material solution at the time of stirring may be lower than the temperature at the time of hydrothermal synthesis, which will be described later, and for example, may be in the range of 0 to 60° C. and preferably in the range of 5 to 50° C. Typically, the temperature of the starting material solution at the time of stirring is an ambient temperature. There are no particular limitations on the upper limit for the stirring time, and the upper limit may, for example, be 100 hours.

After 70 minutes or more have elapsed since the completion of stirring of the starting material solution, the support 11 with the seed crystals deposited thereon is immersed in the starting material solution (step S15). Thereafter, hydrothermal synthesis is started by heating the starting material solution. In the hydrothermal synthesis, LTA-type zeolite grows using the seed crystals as nucleus, and the LTA-type zeolite membrane 12 is formed on the support 11 (step S16). The synthesis temperature at the time of hydrothermal synthesis (the temperature of heating the starting material solution) may be in the range of, for example, 65 to 150° C. and preferably in the range of 70 to 120° C. The hydrothermal synthesis time may be in the range of, for example, 5 to 200 hours and preferably in the range of 10 to 150 hours. Note that the immersion of the support 11 in the starting material solution in step S15 may be conducted before 70 minutes have elapsed since the completion of stirring of the starting material solution. In this case as well, the heating of the starting material solution, i.e., the formation of the zeolite membrane 12 is started after 70 minutes or more have elapsed since the completion of stirring. There are no particular limitations on the upper limit for the amount of time from the completion of stirring to the start of heating of the starting material solution, and the upper limit may, for example, be 1000 minutes.

After the hydrothermal synthesis is completed, the support 11 and the zeolite membrane 12 are cleaned with deionized water. After the cleaning, the support 11 and the zeolite membrane 12 are dried at, for example, 80° C. In the case where the starting material solution contains an SDA, after the drying of the support 11 and the zeolite membrane 12, the zeolite membrane 12 is subjected to heat treatment in an oxidative gas atmosphere so as to remove the SDA in the zeolite membrane 12 by combustion. This results in the formation of through micropores in the zeolite membrane 12. Preferably, the SDA may be almost completely removed. The heating temperature at the time of removing the SDA may be in the range of, for example, 300 to 600° C. The heating time may be in the range of, for example, 1 to 100 hours. The oxidative gas atmosphere is an atmosphere that contains oxygen and may, for example, be under atmospheric air. In the case where the starting material solution does not contain an SDA, the aforementioned heat treatment is not conducted. Through the processing described above, the above-described zeolite membrane complex 1 is obtained.

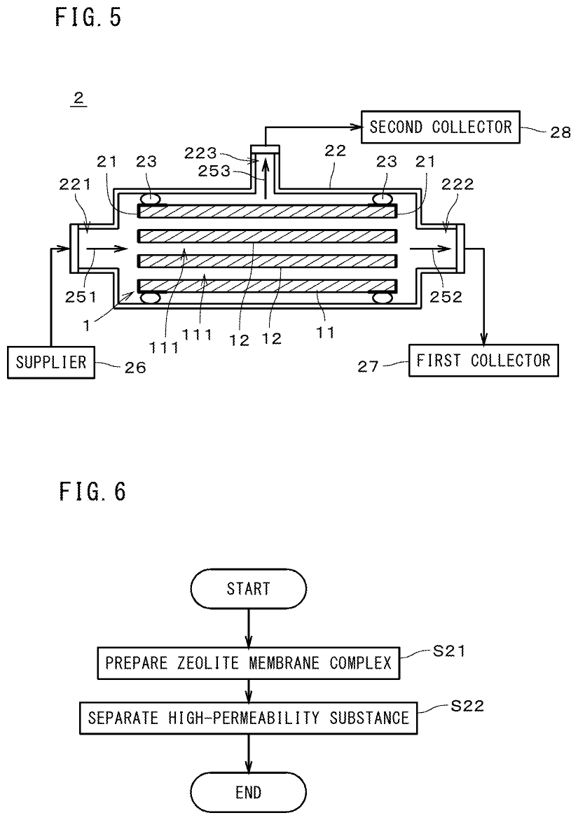

Next, the separation of a mixture of substances using the zeolite membrane complex 1 will be described with reference to FIGS. 5 and 6. FIG. 5 is a diagram showing a separation apparatus 2. FIG. 6 is a flowchart showing the separation of a mixture of substances by the separation apparatus 2.

The separation apparatus 2 supplies a mixture of substances that include a plurality of types of fluid (i.e., gas or liquid) to the zeolite membrane complex 1 and separates a substance having high permeability (hereinafter, also referred to as a “high-permeability substance) in the mixture of substances from the mixture of substances by causing the high-permeability substance to permeate the zeolite membrane complex 1. The separation by the separation apparatus 2 may be conducted, for example, for the purpose of extracting a high-permeability substance from the mixture of substances or for the purpose of condensing a substance having low permeability (hereinafter, also referred to as a “low-permeability substance”).

The mixture of substances (i.e., a fluid mixture) may be a mixed gas that includes a plurality of types of gas, or a mixed solution that includes a plurality of types of liquid, or a gas-liquid two-phase fluid that includes both gas and liquid.

For example, the mixture of substances may contain one or more types of substances selected from among the group consisting of hydrogen (H₂), helium (He), nitrogen (N₂), oxygen (O₂), water (H₂O), carbon monoxide (CO), carbon dioxide (CO₂), nitrogen oxides, ammonia (NH₃), sulfur oxides, hydrogen sulfide (H₂S), sulfur fluorides, mercury (Hg), arsine (AsH₃), hydrogen cyanide (HCN), carbonyl sulfide (COS), C1 to C8 hydrocarbons, organic acid, alcohol, mercaptans, ester, ether, ketone, and aldehyde. The aforementioned high-permeability substance may, for example, be one or more types of substances selected from among the group consisting of H₂, He, N₂, O₂, CO₂, NH₃, and H₂O, and may preferably be H₂O.

Nitrogen oxides are compounds of nitrogen and oxygen. For example, the aforementioned nitrogen oxides may be gas called NOx such as nitrogen monoxide (NO), nitrogen dioxide (NO₂), nitrous oxide (also referred to as dinitrogen monoxide) (N₂O), dinitrogen trioxide (N₂O₃), dinitrogen tetroxide (N₂O₄), or dinitrogen pentoxide (N₂₀₅).

Sulfur oxides are compounds of sulfur and oxygen. For example, the aforementioned sulfur oxides may be gas called SOₓ such as sulfur dioxide (SO₂) or sulfur trioxide (SO₃).

Sulfur fluorides are compounds of fluorine and sulfur. For example, the aforementioned sulfur fluorides may be disulfur difluoride (F—S—S—F, S═SF₂), sulfur difluoride (SF₂), sulfur tetrafluoride (SF₄), sulfur hexafluoride (SF₆), or disulfur decafluoride (S₂F₁₀).

C1 to C8 hydrocarbons are hydrocarbons that contain one or more and eight or less carbon atoms. C3 to C8 hydrocarbons each may be any of a linear-chain compound, a side-chain compound, and a cyclic compound. C2 to C8 hydrocarbons each may be either a saturated hydrocarbon (i.e., where double bonds and triple bonds are not located in molecules) or an unsaturated hydrocarbon (i.e., where double bonds and/or triple bonds are located in molecules). C1 to C4 hydrocarbons may, for example, be methane (CH₄), ethane (C₂H₆), ethylene (C₂H₄), propane (C₃H₈), propylene (C₃H₆), normal butane (CH₃(CH₂)₂CH₃), isobutene (CH(CH₃)₃), 1-butene (CH₂═CHCH₂CH₃), 2-butene (CH₃CH═CHCH₃), or isobutene (CH₂═C(CH₃)₂).

The aforementioned organic acid may, for example, be carboxylic acid or sulfonic acid. The carboxylic acid may, for example, be formic acid (CH₂O₂), acetic acid (C₂H₄O₂), oxalic acid (C₂H₂O₄), acrylic acid (C₃H₄O₂), or benzoic acid (C₆H₅COOH). The sulfonic acid may, for example, be ethane sulfonic acid (C₂H₆O₃S). The organic acid may be a chain compound, or may be a cyclic compound.

The aforementioned alcohol may, for example, be methanol (CH₃OH), ethanol (C₂H₅OH), isopropanol (2-propanol) (CH₃CH(OH)CH₃), ethylene glycol (CH₂(OH)CH₂(OH)), or butanol (C₄H₉OH).

Mercaptans are organic compounds with hydrogenated sulfur (SH) at the terminal and also are substances called thiol or thioalcohol. The aforementioned mercaptans may, for example, be methyl mercaptan (CH₃SH), ethyl mercaptan (C₂H₅SH), or 1-propane thiol (C₃H₇SH).

The aforementioned ester may, for example, be formic acid ester or acetic acid ester.

The aforementioned ether may, for example, be dimethyl ether ((CH₃)₂O), methyl ethyl ether (C₂H₅OCH₃), diethyl ether ((C₂H₅)₂O), or tetrahydrofuran ((CH₂)₄O).

The aforementioned ketone may, for example, be acetone ((CH₃)₂CO), methyl ethyl ketone (C₂H₅COCH₃), or diethyl ketone ((C₂H₅)₂CO).

The aforementioned aldehyde may, for example, be acetaldehyde (CH₃CHO), propionaldehyde (C₂H₅CHO), or butanal (butyraldehyde) (C₃H₇CHO).

The following description is given on the assumption that a mixture of substances to be separated by the separation apparatus 2 is a mixed solution that contains a plurality of types of liquid, and the separation is conducted by pervaporation.

The separation apparatus 2 includes the zeolite membrane complex 1, sealers 21, a housing 22, two seal members 23, a supplier 26, a first collector 27, and a second collector 28. The zeolite membrane complex 1, the sealers 21, and the seal members 23 are placed in the housing 22. The supplier 26, the first collector 27, and the second collector 28 are arranged outside the housing 22 and connected to the housing 22.

The sealers 21 are members that are attached to both ends of the support 11 in the longitudinal direction (i.e., the left-right direction in FIG. 5) and cover and seal both end faces of the support 11 in the longitudinal direction and the outer surface in the vicinity of the both end faces. The sealers 21 prevent an inflow and outflow of liquid from the both end faces of the support 11. For example, the sealer 21 may be a plate-like member made of glass or resin. The material and shape of the sealer 21 may be changed as appropriate. Note that the sealer 21 has a plurality of openings that overlap the plurality of through holes 111 of the support 11, so that both ends of the through holes 111 of the support 11 in the longitudinal direction are not covered with the sealers 21. This allows the inflow and outflow of fluid or the like from the both ends into and out of the through holes 111.

There are no particular limitations on the shape of the housing 22, and for example, the housing 22 may be an approximately cylinder-like tubular member. For example, the housing 22 may be formed of stainless steel or carbon steel. The longitudinal direction of the housing 22 is approximately parallel to the longitudinal direction of the zeolite membrane complex 1. One end of the housing 22 in the longitudinal direction (i.e., the end on the left side in FIG. 5) is provided with a supply port 221, and the other end thereof is provided with a first exhaust port 222. The side face of the housing 22 is provided with a second exhaust port 223. The supply port 221 is connected to the supplier 26. The first exhaust port 222 is connected to the first collector 27. The second exhaust port 223 is connected to the second collector 28. The internal space of the housing 22 is an enclosed space isolated from the space around the housing 22.

The two seal members 23 are arranged around the entire circumference between the outer surface of the zeolite membrane complex 1 and the inner surface of the housing 22 in the vicinity of the both ends of the zeolite membrane complex 1 in the longitudinal direction. Each seal member 23 is an approximately ring-shaped member formed of a material that is impermeable to liquid. For example, the seal members 23 may be O-rings formed of resin having flexibility. The seal members 23 are in tight contact with the outer surface of the zeolite membrane complex 1 and the inner surface of the housing 22 along the entire circumference. In the example shown in FIG. 5, the seal members 23 are in tight contact with the outer surfaces of the sealers 21 and are in indirect tight contact with the outer surface of the zeolite membrane complex 1 via the sealers 21. The space between the seal members 23 and the outer surface of the zeolite membrane complex 1 and the space between the seal members 23 and the inner surface of the housing 22 are sealed so as to almost or completely disable the passage of liquid.

The supplier 26 supplies a mixed solution to the internal space of the housing 22 via the supply port 221. For example, the supplier 26 may include a pump that sends the mixed solution toward the housing 22 under pressure. The pump includes a temperature controller and a pressure regulator that respectively adjust the temperature and pressure of the mixed solution supplied to the housing 22. For example, the first collector 27 may include a reservoir that stores a liquid derived from the housing 22, or a pump that transfers the liquid. The second collector 28 may include, for example, a vacuum pump that reduces the pressure in the space outside the outer surface of the zeolite membrane complex 1 in the housing 22 (i.e., the space sandwiched between the two seal members 23), and a cooling chiller trap that cools and liquefies a gas transmitted through the zeolite membrane complex 1 while vaporizing.

In the separation of the mixed solution, the aforementioned separation apparatus 2 is prepared for the preparation of the zeolite membrane complex 1 (step S21 in FIG. 6). Then, the supplier 26 supplies, to the internal space of the housing 22, a mixed solution that includes a plurality of types of liquid each having different permeability through the zeolite membrane 12. For example, the mixed solution may be composed predominantly of water (H₂O) and ethanol (C₂H₅OH). The mixed solution may further contain liquid other than water and ethanol. The pressure of the mixed solution supplied from the supplier 26 to the internal space of the housing 22 (i.e., feed pressure) may be in the range of, for example, 0.1 MPa to 2 MPa, and the temperature of the mixed solution may be in the range of, for example, 10° C. to 200° C.

The mixed solution supplied from the supplier 26 to the housing 22 is fed from the left end of the zeolite membrane complex 1 in the drawing into each through hole 111 of the support 11 as indicated by an arrow 251. A high-permeability substance that is the liquid with high permeability in the mixed solution permeates the zeolite membrane 12 formed on the inside surface of each through hole 111 and then through the support 11 while evaporating, and is then derived from the outer surface of the support 11. Accordingly, the high-permeability substance (e.g., water) is separated from a low-permeability substance (e.g., ethanol) that is the liquid with low permeability in the mixed solution (step S22).

The gas derived from the outer surface of the support 11 (hereinafter, referred to as a “permeate substance”) is guided via the second exhaust port 223 to the second collector 28 as indicated by an arrow 253 and is then cooled and collected as a liquid in the second collector 28. The pressure of the gas collected by the second collector 28 via the second exhaust port 223 (i.e., permeate pressure) may, for example, be approximately 6.67 kPa (approximately 50 Torr). The permeate substance may further include a low-permeability substance that has permeated the zeolite membrane 12, in addition to the aforementioned high-permeability substance.

In the mixed solution, the liquid (hereinafter, referred to as a “non-permeate substance”) other than the substances that have permeated the zeolite membrane 12 and the support 11 passes through each through hole 111 of the support 11 from the left side to the right side in the drawing and is collected by the first collector 27 via the first exhaust port 222 as indicated by an arrow 252. The pressure of the liquid collected by the first collector 27 via the first exhaust port 222 may, for example, be approximately the same as the feed pressure. The non-permeate substance may further include a high-permeability substance that has not permeated the zeolite membrane 12, in addition to the aforementioned low-permeability substance. For example, the non-permeate substance collected by the first collector 27 may be circulated to the supplier 26 and supplied again to the inside of the housing 22.

For example, the separation apparatus 2 shown in FIG. 5 may be used as a membrane reactor. In this case, the housing 22 is used as a reactor. Inside the housing 22, a catalyst is placed that accelerates chemical reactions of starting materials supplied from the supplier 26. For example, the catalyst may be arranged between the supply port 221 and the first exhaust port 222. Preferably, the catalyst may be arranged in the vicinity of the zeolite membrane 12 of the zeolite membrane complex 1. The catalyst to be used is made of an adequate material and has an adequate shape depending on the types of the starting materials and the types of chemical reactions caused by the starting materials. The starting materials include one or two or more types of substances. In order to accelerate the chemical reactions of the starting materials, the membrane reactor may further include a heater for heating the reactor (i.e., housing 22) and the starting materials.

In the separation apparatus 2 used as a membrane reactor, a mixture of substances that include a product substance produced by chemical reactions of the starting materials in the presence of the catalyst is supplied to the zeolite membrane 12 in the same manner as described above, and a high-permeability substance in the mixture of substances is separated from other substances having lower permeability than the high-permeability substance as a result of permeating the zeolite membrane 12. For example, the mixture of substances may be fluid that includes the product substance and an unreacted starting material. Alternatively, the mixture of substances may include two or more types of product substances. The high-permeability substance may be a product substance produced from a starting material, or may be a substance other than a product substance. Preferably, the high-permeability substance may include one or more types of product substances.

In the case where the high-permeability substance is a product substance produced from a starting material, the yield of the product substance can be improved by separating the product substance from the other substances through the zeolite membrane 12. In the case where the mixture of substances includes two or more types of product substances, these two or more types of product substances may be high-permeability substances, or only some of the two or more types of product substances may be high-permeability substances.

Next, zeolite membrane complexes according to Examples 1 to 9 and Comparative Examples 1 to 4 will be described. Table 1 shows the composition (molar ratio) of the starting material solution used to form an LTA-type zeolite membrane, the stirring time, the amount of time from the completion of stirring to the start of heating, the synthesis temperature, and the synthesis time.

TABLE 1

| | | | | | | Amount of Time from | | |
|---|---|---|---|---|---|---|---|---|
| | | | | | | Completion of | Synthesis | |
| | Composition of Starting Material Solution | | | | Stirring | Stirring to Start of | Tem- | Synthesis |
| | [Molar Ratio] | | | | Time | Heating | perature | Time |
| | SiO₂/Al₂O₃ | H₂O/Na₂O | Na₂O/SiO₂ | SDA/Al₂O₃ | [h] | [min] | [° C.] | [h] |
| Example 1 | 4.35 | 398 | 0.28 | — | 12 | 70 | 80 | 40 |
| Example 2 | 4.85 | 729 | 0.25 | — | 12 | 70 | 80 | 100 |
| Example 3 | 6.50 | 477 | 0.22 | 1.8 | 10 | 70 | 100 | 60 |
| Example 4 | 4.35 | 564 | 0.28 | — | 10 | 70 | 80 | 40 |
| Example 5 | 5.35 | 974 | 0.13 | — | 10 | 70 | 80 | 100 |
| Example 6 | 4.35 | 1173 | 0.30 | — | 10 | 70 | 80 | 120 |
| Example 7 | 6.35 | 1173 | 0.21 | — | 10 | 70 | 80 | 150 |
| Example 8 | 4.60 | 114 | 0.33 | — | 10 | 70 | 80 | 20 |
| Example 9 | 4.85 | 185 | 0.54 | — | 12 | 70 | 80 | 40 |
| Comparative | 5.00 | 240 | 1.00 | — | 6 | 70 | 80 | 10 |
| Example 1 | | | | | | | | |
| Comparative | 4.35 | 148 | 0.44 | — | 6 | 70 | 80 | 20 |
| Example 2 | | | | | | | | |
| Comparative | 4.60 | 114 | 0.33 | — | 10 | 40 | 80 | 40 |
| Example 3 | | | | | | | | |
| Comparative | 10.00 | 221 | 0.15 | 2.6 | 10 | 70 | 100 | 60 |
| Example 4 | | | | | | | | |

### Preparation of Seed Crystals

Solution A was prepared by adding colloidal silica (LUDOX AS-40 manufactured by Sigma-Aldrich Co. LLC) serving as a Si source to a tetramethylammonium hydroxide solution (a 15% water solution manufactured by FUJIFILM Wako Pure Chemical Corporation) serving as an SDA and by stirring a resultant solution for 30 minutes. Solution B was prepared by adding sodium hydroxide (manufactured by Sigma-Aldrich Co. LLC) serving as a Na source and sodium aluminate powder (manufactured by Sigma-Aldrich Co. LLC) serving as an Al source to deionized water and by stirring a resultant solution until the solution became transparent. Solution B was dropped into Solution A, and a resultant solution was stirred for 24 hours or more at ambient temperature so as to prepare a starting material solution for seed crystals having a composition of 1Al₂O₃:6.5SiO₂:1.45Na₂O:1.8(TMA)₂O:320H₂O.

The starting material solution for seed crystals was subjected to hydrothermal synthesis at 100° C. for 60 hours to obtain an LTA-type zeolite crystal. The resultant LTA-type zeolite crystal was subjected to heat treatment at 450° C. for 15 hours so as to remove the SDA by combustion. The heated LTA-type zeolite crystal was pulverized into seed crystals for 45 hours in a ball mill. According to measurements made by energy dispersed X-ray spectroscopy in the same manner as in the case of “Measurements of Si/Al Ratio in Membrane” described later, the Si/Al molar ratio in the seed crystals was higher than or equal to 2.4. Thereafter, a porous alumina support of a monolith shape was brought into contact with a solution in which the aforementioned seed crystals were dispersed, so that the seed crystals were deposited on the insides of the cells, which were through holes of the support.

### Preparation of LTA Membrane

Sodium hydroxide (manufactured by Sigma-Aldrich Co. LLC) serving as a Na source and sodium aluminate powder (manufactured by Sigma-Aldrich Co. LLC) serving as an Al source were mixed with deionized water. In Example 3 and Comparative Example 4, a tetramethyla mmonium hydroxide solution serving as an SDA was further mixed together. After the mixed solution was stirred for one hour at ambient temperature, colloidal silica (SNOW TEX-50T manufactured by Nissan Chemical Corporation) serving as a Si source was added to the mixed solution so as to obtain a starting material solution. If it was assumed that all of the Si source, the Al source, and the Na source existed as oxides, the SiO₂/Al₂O₃ molar ratio, the H₂O/Na₂O molar ratio, the Na₂O/SiO₂ molar ratio, and the SDA/Al₂O₃ molar ratio in the starting material solution were as shown in Table 1. In Examples 1 to 9, the SiO₂/Al₂O₃ molar ratios were set in the range of 4 to 7, the H₂O/Na₂O molar ratios were set in the range of 100 to 1200, and the Na₂O/SiO₂ molar ratios were set in the range of 0.1 to 0.6. In Comparative Example 1, on the other hand, the Na₂O/SiO₂ molar ratio was set to 1.0, which was higher than the aforementioned range. In Comparative Example 4, the SiO₂/Al₂O₃ molar ratio was set to 10, which was higher than the aforementioned range.

Then, the starting material solution was stirred at ambient temperature. The stirring time of the starting material solution was as shown in Table 1. In Examples 1 to 9, the stirring time of the starting material solution was set to 10 hours or more. In Comparative Examples 1 and 2, on the other hand, the stirring time of the starting material solution was set to 6 hours.

After the amount of time indicated by “Amount of Time from Completion of Stirring to Start of Heating” in Table 1 had elapsed since the completion of stirring of the starting material solution, the support with the seed crystals deposited thereon was immersed in the starting material solution, and heating (hydrothermal synthesis) of the starting material solution was started. The synthesis temperature and the synthesis time at the time of hydrothermal synthesis were as shown in Table 1. In this way, the LTA-type zeolite membrane was formed on the support. In Examples 1 to 9, the amount of time from the completion of stirring to the start of heating was set to 70 minutes or more. In Comparative Example 3, on the other hand, the amount of time from the completion of stirring to the start of heating was set to 40 minutes.

After the hydrothermal synthesis, the support and the zeolite membrane were cleaned enough with deionized water and dried at 80° C. In Example 3 and Comparative Example 4 in which the starting material solution contained an SDA, the LTA-type zeolite membrane was subjected to heat treatment at 450° C. for 30 hours so as to remove the SDA by combustion. Through the processing described above, the zeolite membrane complexes each including the LTA-type zeolite membrane according to Examples 1 to 9 and Comparative Examples 1 to 4 were obtained.

Table 2 shows the Si/Al ratio, the XRD peak intensity ratio, water/ethanol separation performance, hydrothermal endurance, and strength for the LTA-type zeolite membrane.

TABLE 2

| | | | | Water/Ethanol Separation | | Hydrothermal | |
|---|---|---|---|---|---|---|---|
| | | | | Performance | | Endurance | Strength |
| | | | | Total | | Separation Factor After | Separation Factor After |
| | | XRD Diffraction Peak | | Permeation | Separation | Hot Water Immersion/ | Hydraulic Pressing/ |
| | Si/Al | Intensity Ratio | | Flux | Factor | Separation Factor Before | Separation Factor Before |
| | Ratio | 24.0°/7.2° | 30.0°/7.2° | (kg/m²h] | [—] | Hot Water Immersion | Hydraulic Pressing |
| Example 1 | 1.74 | 1.21 | 1.11 | ≥2 | ≥2000 | 0.71 | 1.00 |
| Example 2 | 2.11 | 1.09 | 1.10 | ≥2 | ≥2000 | 0.82 | 1.00 |
| Example 3 | 2.80 | 0.95 | 0.97 | ≥2 | ≥2000 | 0.90 | 1.00 |
| Example 4 | 1.81 | 0.86 | 0.88 | ≥2 | ≥2000 | 0.76 | 0.90 |
| Example 5 | 2.32 | 0.89 | 0.89 | ≥2 | ≥2000 | 0.80 | 0.95 |
| Example 6 | 2.20 | 0.90 | 0.80 | ≥2 | ≥2000 | 0.83 | 0.92 |
| Example 7 | 2.40 | 0.92 | 0.88 | ≥2 | ≥2000 | 0.85 | 0.92 |
| Example 8 | 1.20 | 0.99 | 0.92 | ≥2 | ≥2000 | 0.51 | 1.00 |
| Example 9 | 1.60 | 0.90 | 1.01 | ≥2 | ≥2000 | 0.67 | 1.00 |
| Comparative | 1.03 | 0.75 | 0.71 | ≥2 | ≥2000 | 0.12 | 0.42 |
| Example 1 | | | | | | | |
| Comparative | 1.25 | 0.81 | 0.83 | ≥2 | ≥2000 | 0.53 | 0.52 |
| Example 2 | | | | | | | |
| Comparative | — | — | — | ≥2 | 156 | — | — |
| Example 3 | | | | | | | |
| Comparative | 2.92 | Dense membrane was not prepared | | | | | |
| Example 4 | | | | | | | |

### Measurements of Si/Al Ratio in Membrane

The Si/Al molar ratio (“Si/Al Ratio” in Table 2) in a section of the zeolite membrane was measured by scanning electron microscope-energy dispersed X-ray spectroscopy (SEM-EDX). The acceleration voltage was set to 15 kV. In Examples 1 to 9 in which the stirring time of the starting material solution was set to 10 hours or more and the amount of time from the completion of stirring to the start of heating was set to 70 minutes or more, all the Si/Al ratios were higher than or equal to 1.2. In particular, in Examples 1 to 7 in which the H₂O/Na₂O molar ratio in the starting material solution was set to 350 or higher, the Si/Al ratios were in the range of 1.74 to 2.80. In Comparative Examples 1 and 2 in which the stirring time of the starting material solution was set to 6 hours, on the other hand, the Si/Al ratios were 1.03 and 1.25, respectively. In Comparative Example 3 in which the amount of time from the completion of stirring to the start of heating was set to 40 minutes, an adequate separation membrane was not formed and a separation factor was extremely small in a “Water/Ethanol Separation Test” described later, so that no measurements other than the “Water/Ethanol Separation Test” were conducted. In Comparative Example 4 in which the SiO₂/Al₂O₃ molar ratio in the starting material solution was set to 10, the Si/Al ratio was 2.92, but a dense membrane was not formed, so that no measurements other than the measurement of the Si/Al ratio were conducted.

### XRD Measurement of Membrane

Diffraction patterns on surfaces of the zeolite membranes according to Examples 1 to 9 and Comparative Examples 1 and 2 were measured by X-ray diffraction measurement. In Examples 1 to 9 and Comparative Examples 1 and 2, it was confirmed from the X-ray diffraction patterns that the LTA-type zeolite membranes were formed. In Examples 1 to 9, in the X-ray diffraction patterns, the ratios of the peak intensity around 2θ=24.0° to the peak intensity around 2θ=7.2° (“24.0°/7.2°” in Table 2; hereinafter, simply referred to as the “24.0°/7.2° intensity ratio”) were higher than or equal to 0.85. In Examples 1 to 3 and 6 to 9, the 24.0°/7.2° intensity ratios were higher than or equal to 0.90. In Examples 1 to 5 and 7 to 9, the ratios of the peak intensity around 2θ=30.0° to the peak intensity around 2θ=7.2° (“30.0°/7.2°” in Table 2; hereinafter, simply referred to as the “30.0°/7.2° intensity ratio”) were higher than or equal to 0.85. In Examples 1 to 3, 8, and 9, the 30.0°/7.2° intensity ratios were higher than or equal to 0.90. In Comparative Examples 1 and 2 in which the stirring time of the starting material solution was set to 6 hours, on the other hand, the 24.0°/7.2° intensity ratio and the 30.0°/7.2° intensity ratio were both lower than 0.85.

The X-ray diffraction measurements were conducted using the X-ray diffractometer manufactured by Rigaku Corporation (device name; MiniFlex600), with a tube voltage of 40 kV, a tube current of 15 mA, a scanning speed of 0.5°/min, and a scanning step of 0.02°. Moreover, the divergence slit was 1.25°, the scattering slit was 1.25°, the receiving slit was 0.3 mm, the incident Soller slit was 5.0°, and the receiving Soller slit was 5.0°. The X-ray diffraction measurements did not use any monochromator and used 0.015 mm thick nickel foil as a CuKβ-ray filter.

### Water/Ethanol Separation Test

The water/ethanol separation test was conducted by pervaporation, using the above-described separation apparatus 2. In the test, a mixed solution having a temperature of 60° C. and containing 50 mass % of water and 50 mass % of ethanol was supplied from the supplier 26 via the supply port 221 to the housing 22 under atmospheric pressure. The pressure at the second exhaust port 223 on the permeate side of the zeolite membrane complex was reduced to −94.66 kPaG (approximately 50 Torr). The gas that had permeated the zeolite membrane and had been derived from the outer surface of the support 11 was cooled and collected as a liquid by the second collector 28. The amount of fluid that had permeated a unit area of the membrane per unit time, i.e., a total permeation flux (kg/m² h), was calculated from the mass of the liquid collected by the second collector 28. Moreover, the concentrations (mass %) of water and ethanol in the liquid were measured, and the water concentration/the ethanol concentration was acquired as a separation factor.

In Examples 1 to 9 and Comparative Examples 1 to 3 in which the aforementioned measurement was conducted, the total permeation fluxes were higher than or equal to 2 kg/m² h. The separation factors were greater than or equal to 2000 and favorable, except the separation factor in Comparative Example 3. In Comparative Example 3, the separation factor was 156 and extremely small.

### Evaluation of Hydrothermal Endurance

In the evaluation of the hydrothermal endurance, the zeolite membrane complex was immersed in deionized water having a temperature of 60° C. for 6 hours and then dried at 80° C. for 12 hours or more. Thereafter, the “water/ethanol separation test” described above was conducted again to measure the separation factor, and the ratio of the separation factor after immersion to the separation factor before immersion (“Separation Factor after Hot Water Immersion/Separation Factor before Hot Water Immersion” in Table 2) was defined as an indicator of the hydrothermal endurance.

In Examples 1 to 9, the ratios of the separation factor after immersion to the separation factor before immersion were higher than or equal to 0.5. In Examples 1 to 7 in which the Si/Al molar ratios were in the range of 1.74 to 2.80, the ratios of the separation factor after immersion to the separation factor before immersion were higher than or equal to 0.7 and considerably higher than those in Comparative Examples 1 and 2.

### Hydraulic Pressure Test

In the hydraulic pressure test, firstly, each zeolite membrane complex was arranged so as to have a longitudinal direction oriented approximately in the vertical direction. Then, the zeolite membrane complex was subjected to hydraulic pressing by introducing deionized water having ambient temperature into each through hole from the lower opening of the through hole and pressurizing the water in the through hole. The pressing pressure was set to 10 MPaG, and the pressing time was set to one minute. After the zeolite membrane complex was dried at 80° C. for 12 hours or more, the “water/ethanol separation test” described above was conducted again to measure the separation factor, and the ratio of the separation factor after hydraulic pressing to the separation factor before hydraulic pressing (“Separation Factor after Hydraulic Pressing/Separation Factor before Hydraulic Pressing” in Table 2) was defined as an indicator of the strength.

In Examples 1 to 9 in which at least either the 24.0°/7.2° intensity ratio or the 30.0°/7.2° intensity ratio was higher than or equal to 0.85, the ratios of the separation factor after hydraulic pressing to the separation factor before hydraulic pressing were higher enough than those in Comparative Examples 1 and 2. That is, the strength of the zeolite membrane complexes according to Examples 1 to 9 was improved from the strength of the zeolite membrane complexes according to Comparative Examples 1 and 2. In Examples 1 to 3, 8, and 9 in which both of the 24.0°/7.2° intensity ratio and the 30.0°/7.2° intensity ratio were higher than or equal to 0.90, the ratios of the separation factor after hydraulic pressing to the separation factor before hydraulic pressing became one, i.e., the separation factors remained unchanged before and after hydraulic pressing.

Even in Examples 4 and 5 in which the 24.0°/7.2° intensity ratio and the 30.0°/7.2° intensity ratio were slightly higher than 0.85, the ratios of the separation factor after hydraulic pressing to the separation factor before hydraulic pressing were higher enough than those in Comparative Examples 1 and 2. Accordingly, it is conceivable that the strength of the zeolite membrane complex can improve if at least either the 24.0°/7.2° intensity ratio or the 30.0°/7.2° intensity ratio is higher than or equal to 0.85.

As described above, the zeolite membrane complex 1 includes the porous support 11 and the zeolite membrane 12 made of an LTA-type zeolite and formed on the support 11. The Si/Al molar ratio in the zeolite membrane 12 is higher than or equal to 1.74 and lower than or equal to 2.80. Accordingly, it is possible to provide the zeolite membrane complex 1 that has improved hydrothermal endurance (see Examples 1 to 7) and allows long-time use.

Preferably, in the X-ray diffraction pattern obtained by X-ray irradiation of the surface of the zeolite membrane 12, at least either the peak intensity around 2θ=24.0° or the peak intensity around 2θ=30.0° may be 0.85 times or more the peak intensity around 2θ=7.2°. Accordingly, it is possible to provide the zeolite membrane complex 1 that has improved strength in addition to improved hydrothermal endurance (see Examples 1 to 7). In order to further improve the strength of the zeolite membrane complex 1, it is preferable that both of the peak intensity around 2θ=24.0° and the peak intensity around 2θ=30.0° are 0.90 times or more the peak intensity around 2θ=7.2° (see Examples 1 to 3).

From the viewpoint of ensuring a certain degree of hydrothermal endurance of the zeolite membrane complex 1, the Si/Al molar ratio in the zeolite membrane 12 may be higher than or equal to 1.2 (see Examples 1 to 9). Even in this case, if, in the X-ray diffraction pattern described above, at least either the peak intensity around 2θ=24.0° or the peak intensity around 2θ=30.0° is 0.85 times or more the peak intensity around 2θ=7.2°, it is possible to improve the strength of the zeolite membrane complex 1 (see Examples 1 to 9). In order to further improve the strength of the zeolite membrane complex 1 in the same manner as described above, it is preferable that both of the peak intensity around 2θ=24.0° and the peak intensity around 2θ=30.0° are 0.90 times or more the peak intensity around 2θ=7.2° (see Examples 1 to 3, 8, and 9).

Preferably, the zeolite membrane 12 may have a thickness of less than or equal to 5 μm. The zeolite membrane complex 1 allows a reduction in the thickness of the zeolite membrane 12 while improving its hydrothermal endurance and/or strength and allows an improvement in permeance to high-permeability substances.

In a preferable zeolite membrane complex 1, when a mixed solution having a temperature of 60° C. and containing 50 mass % of water and 50 mass % of ethanol is supplied with a permeate pressure of −94.66 kPaG, the total permeation flux is higher than or equal to 2.0 kg/m² h and the separation factor of water to ethanol is greater than or equal to 2000. This enables appropriate separation of the mixed solution of water and ethanol.

As described above, the membrane reactor includes the above-described zeolite membrane complex 1, the catalyst that accelerates chemical reactions of starting materials, the reactor (in the aforementioned example, the housing 22) in which the zeolite membrane complex 1 and the catalyst are placed, and the supplier 26 that supplies the starting materials to the reactor. The zeolite membrane complex 1 separates a high-permeability substance having high permeability in a mixture of substances from other substances by allowing the high-permeability substance to permeate the zeolite membrane complex 1, the mixture of substances including a product substance generated by chemical reactions of the starting materials in the presence of the catalyst. Accordingly, it is possible to efficiently separate the high-permeability substance from the other substances in the same manner as described above. The membrane reactor is in particular suitable for the separation of H₂O.

The method of producing the zeolite membrane complex 1 includes the step of preparing a starting material solution (step S13), the step of stirring the starting material solution for 10 hours or more after step S13 (step S14), the step of immersing the porous support 11 with seed crystals deposited thereon in the starting material solution, the seed crystals including an LTA-type zeolite (step S15), and the step of forming the zeolite membrane 12 made of an LTA-type zeolite on the support 11 by heating the starting material solution after 70 minutes or more have elapsed since the completion of step S14 (step S16). In step S13, the starting material solution is prepared by mixing the Na source, the Al source, and the Si source with water. The starting material solution has a SiO₂/Al₂O₃ molar ratio of higher than or equal to 4 and lower than or equal to 7, an H₂O/Na₂O molar ratio of higher than or equal to 100 and lower than or equal to 1200, and a Na₂O/SiO₂ molar ratio of higher than or equal to 0.1 and lower than or equal to 0.6 (see Examples 1 to 9).

In the above-described production method, the stirring time of the starting material solution is set to 10 hours or more in order to improve uniformity of the starting material solution. This prevents crystals from being oriented and allows random growth of the crystals. Besides, since the heating of the starting material solution is started after 70 minutes or more have elapsed since the completion of stirring, starting material particles are moderately flocculated into starting material particles of appropriate dimensions at the start of the heating. This allows control of the rate of crystal growth and reduces the generation of membranous defects (e.g., the generation of hetero-facies or impurities). As a result, it is possible to produce the favorable zeolite membrane complex 1 with improved hydrothermal endurance and/or strength. Note that the presence or absence of hetero-facies or impurities may be confirmed by X-ray diffraction measurements conducted on the surface of the zeolite membrane 12.

Preferably, the starting material solution has an H₂O/Na₂O molar ratio of higher than or equal to 350 (see Examples 1 to 7). This more reliably improves the hydrothermal endurance of the zeolite membrane complex 1. Preferably, the seed crystals have a Si/Al molar ratio of higher than or equal to 2.4. This allows more reliable production of the preferable zeolite membrane complex 1. Depending on the performance required for the zeolite membrane complex 1, the H₂O/Na₂O molar ratio in the starting material solution may be lower than 350, and the Si/Al molar ratio in the seed crystals may be lower than 2.4.

The zeolite membrane complex 1, the membrane reactor, and the method of producing the zeolite membrane complex 1 described above may be modified in various ways.

In the case where high strength is not required for the zeolite membrane complex 1, in the X-ray diffraction pattern, the peak intensity around 2θ=24.0° and the perk intensity around 2θ=30.0° may be less than 0.85 times the peak intensity around 2θ=7.2°.

The zeolite membrane complex 1 may be produced by a method other than the above-described production method.

The zeolite membrane complex 1 may further include, in addition to the support 11 and the zeolite membrane 12, a functional membrane or a protection membrane that is laminated on the zeolite membrane 12. Such a functional or protection membrane may be an inorganic membrane such as a zeolite membrane, a silica membrane, or a carbon membrane, or may be an organic membrane such as a polyimide membrane or a silicone membrane. Moreover, a substance that can easily adsorb water may be added to the functional or protection membrane laminated on the zeolite membrane 12.

In the separation apparatus 2, the membrane reactor, and the separation method, the separation of a mixture of substances may be conducted by a different method such as vapor permeation, reverse osmosis, or gas permeation other than pervaporation described above.

In the separation apparatus 2, the membrane reactor, and the separation method, a substance other than those exemplified in the above description may be separated from a mixture of substances.

The constitutions of the above-described preferred embodiment and the variations may be appropriately combined as long as there are no mutual inconsistencies.

While the invention has been shown and described in detail, the foregoing description is in all aspects illustrative and not restrictive. It is therefore to be understood that numerous modifications and variations can be devised without departing from the scope of the invention.

### INDUSTRIAL APPLICABILITY

The zeolite membrane complex according to the present invention is applicable as, for example, a dehydrating membrane and is also applicable as, for example, a separation membrane for separating various substances other than water or as an adsorption membrane for adsorbing various substances in various fields using zeolites.

### REFERENCE SIGNS LIST

1 zeolite membrane complex
11 support
12 zeolite membrane
S11 to S16, S21, S22 step

1. A zeolite membrane complex comprising:
a porous support; and
a zeolite membrane made of an LTA-type zeolite and formed on said support,
wherein said zeolite membrane has a Si/Al molar ratio of higher than or equal to 1.74 and lower than or equal to 2.80.

2. The zeolite membrane complex according to claim 1, wherein
in an X-ray diffraction pattern obtained by X-ray irradiation of a surface of said zeolite membrane, at least either a peak intensity around 2θ=24.0° or a peak intensity around 2θ=30.0° is 0.85 times or more a peak intensity around 2θ=7.2°.

3. A zeolite membrane complex comprising:
a porous support; and
a zeolite membrane made of an LTA-type zeolite and formed on said support,
wherein said zeolite membrane has a Si/Al molar ratio of higher than or equal to 1.2, and
in an X-ray diffraction pattern obtained by X-ray irradiation of a surface of said zeolite membrane, at least either a peak intensity around 2θ=24.0° or a peak intensity around 2θ=30.0° is 0.85 times or more a peak intensity around 2θ=7.2°.

4. The zeolite membrane complex according to claim 1, wherein
said zeolite membrane has a thickness of less than or equal to 5 μm.

5. The zeolite membrane complex according to claim 1, wherein
when a mixed solution having a temperature of 60° C. and containing 50 mass % of water and 50 mass % of ethanol is supplied with a permeate pressure of −94.66 kPaG, a total permeation flux is higher than or equal to 2.0 kg/m² h, and a separation factor of water to ethanol is greater than or equal to 2000.

6. The zeolite membrane complex according to claim 3, wherein
said zeolite membrane has a thickness of less than or equal to 5 μm.

7. The zeolite membrane complex according to claim 3, wherein
when a mixed solution having a temperature of 60° C. and containing 50 mass % of water and 50 mass % of ethanol is supplied with a permeate pressure of −94.66 kPaG, a total permeation flux is higher than or equal to 2.0 kg/m² h, and a separation factor of water to ethanol is greater than or equal to 2000.

8. A membrane reactor comprising:
the zeolite membrane complex according to claim 1;
a catalyst that accelerates a chemical reaction of a starting material;
a reactor in which said zeolite membrane complex and said catalyst are placed; and
a supplier that supplies said starting material to said reactor,
wherein said zeolite membrane complex separates a high-permeability substance having high permeability in a mixture of substances from other substances by allowing the high-permeability substance to permeate the zeolite membrane complex, the mixture of substances containing a product substance generated by a chemical reaction of said starting material in the presence of said catalyst.

9. A membrane reactor comprising:
the zeolite membrane complex according to claim 3;
a catalyst that accelerates a chemical reaction of a starting material;
a reactor in which said zeolite membrane complex and said catalyst are placed; and
a supplier that supplies said starting material to said reactor,
wherein said zeolite membrane complex separates a high-permeability substance having high permeability in a mixture of substances from other substances by allowing the high-permeability substance to permeate the zeolite membrane complex, the mixture of substances containing a product substance generated by a chemical reaction of said starting material in the presence of said catalyst.

10. A method of producing a zeolite membrane complex, comprising:
a) preparing a starting material solution by mixing a sodium source, an aluminum source, and a silicon source with water;
b) after said operation a), stirring said starting material solution for 10 hours or more;
c) immersing a porous support in said starting material solution, the porous support having a seed crystal deposited thereon, the seed crystal including an LTA-type zeolite; and
d) after 70 minutes or more has elapsed since completion of said operation b), heating said starting material solution to form a zeolite membrane made of an LTA-type zeolite on said support with said seed crystal deposited thereon,
wherein said starting material solution has a SiO₂/Al₂O₃ molar ratio of higher than or equal to 4 and lower than or equal to 7, an H₂O/Na₂O molar ratio of higher than or equal to 100 and lower than or equal to 1200, and a Na₂O/SiO₂ molar ratio of higher than or equal to 0.1 and lower than or equal to 0.6.

11. The method of producing a zeolite membrane complex according to claim 9, wherein
said starting material solution has an H₂O/Na₂O molar ratio of higher than or equal to 350.

12. The method of producing a zeolite membrane complex according to claim 9, wherein
said seed crystal has a Si/Al molar ratio of higher than or equal to 2.4.
